(19) United States
(12) Patent Application Publication
(10) Pub. No.: US 2022/0311510 A1
(43) Pub. Date: Sep. 29, 2022

(54) FIBER OPTIC LINK EQUALIZATION IN DATA CENTERS AND OTHER TIME SENSITIVE APPLICATIONS

(71) Applicant: Douglas Arthur Pinnow, Oceanside, CA (US)

(72) Inventors: Gary Evan Miller, Holly Springs, NC (US); Charles Lemmey Byrd, JR., Smithfield, NC (US); Jonathan Trey Benfield, Raleigh, NC (US)

(73) Assignee: M2 Optics, Inc., Rayleigh, NC (US)

(21) Appl. No.: 17/703,589

(22) Filed: Mar. 24, 2022

Related U.S. Application Data
(60) Provisional application No. 63/165,575, filed on Mar. 24, 2021.

(51) Int. Cl. H04B 10/071; H04B 10/079; G02B 6/38; G02B 6/44

(52) U.S. Cl. CPC H04B 10/071; H04B 10/0795; G02B 6/3897; G02B 6/4457

(57) ABSTRACT

A novel method and apparatus are described that can be used to equalize the latency in fiber optic distribution links within data centers containing multiple pods (clusters of servers) and thereby improve the overall operation and utility of the data center for multiple customers. Specifically, the apparatus serves to add precisely measured latency (signal delays) to data transmission in certain fiber optic cable links so that there are negligible differences in signal transmission times from the central switch (core router) to each of the distributed pods within a data center. While that purposeful addition of latency may, at first, seem counterintuitive to optimizing the performance of a data center, the effect achieved is quite the opposite. That is because all pods will have equal access to received and transmitted data thereby reducing signal congestion and the unbalanced time favoritism of one pod operator over another to the access incoming data.

### CROSS REFERENCES TO RELATED APPLICATIONS

This application claims the benefit of U.S. Provisional Patent Application No. 63/165,575 filed Mar. 24, 2021, titled FIBER OPTIC LINK EQUALIZATION IN DATA CENTERS AND OTHER TIME SENSITIVE APPLICATIONS, the contents of which are hereby incorporated by reference herein.

### TECHNICAL FIELD AND INDUSTRIAL APPLICABILITY OF THE INVENTION

The invention relates to enhancing the operation and cost-effectiveness of data centers and other arrival time sensitive applications that may arise in the field of robotics and in laboratories by the selective addition of time delays (latency) into the internal cabling architecture for the purpose of equalizing the time delay for data transmission in certain groups of optical fibers.

### BACKGROUND OF THE INVENTION

The flow and processing of digital data throughout the world has grown into a huge business. In most cases, users of digital data employ the services of data centers that concentrate multiple servers and routers in discrete locations (sites) that offer a cost-effective means to ensure the reliable flow and processing of data. Cost-effectiveness is achieved by sharing necessary services; such as air conditioning, electrical power, and security over a relatively large group of servers and routers co-located in a data center rather than duplicating these services for smaller groups of routers and servers that may be geographically disbursed. It is estimated that there are now approximately three million data centers in the United States, one for about every one hundred citizens. The combined value of these data centers is over ten trillion dollars. Most of these data centers house IT (information technology) equipment for a single organization such as a company or government entity. However, approximately two thousand geographically disbursed data centers are shared facilities that offer leased spaces where multiple organizations can house their IT equipment. There are approximately 500 independent operators of these two thousand facilities who compete for lessees.

### DESCRIPTION OF RELATED ART

There is a fundamental reason why these data centers are geographically disbursed throughout the United States rather than being located a single mega-center in a centralized location such as Kansas. The reason is that there is an inherent delay time for the transmission of data from one location to another due to the speed of data packets through optical fibers, metal cables, and through the atmosphere. That limiting speed is the speed of light, 186,000 miles per second (equivalent to a delay of approximately one nanosecond per foot traveled through the atmosphere and approximately two-thirds of that through glass optical fibers).

The total signal delay when dealing with data transmission is known as ‘latency’. In most cases, the operators of data centers strive to minimize latency so that the data flow within their facilities proceeds as quickly as their equipment allows. This strategy usually results in maximizing the cost effectiveness of a data center.

While the root cause of latency is the speed of light through the network medium (normally glass fiber or copper wire), network design also plays a role in latency. Every time a data packet is processed in some way, or every time it transitions from one medium to another, there is some delay. Likewise, latency can be caused by changing from one protocol to another such as from Ethernet to Time Division Multiplexing (TDM). While each individual delay can be quite brief, the total delays is always additive, the sum of the individual delays.

Networks with poor design (such as inefficient routers, unnecessary media transitions, or routing paths that lead through low-speed networks) add to latency. So do communication problems on inefficient servers, and overloaded routers. And, of course, latency can be made worse if the network end points (ranging from workstations to storage servers) aren't properly configured, are poorly chosen, or are overloaded.

When the public Internet is used as part of the network path, latency can get dramatically increased. Because one cannot prioritize the flow of data packets over the Internet, those packets can be routed through very slow pathways, congested networks, or sent over pathways that are much longer than necessary. For example, it's not uncommon for an endpoint in Denver to find its data routed through New York on its way to Seattle.

According to Verizon's latest IP latency statistics, data travels round trip across the Atlantic Ocean in just less than 80 milliseconds, and it travels across the Pacific Ocean in just more than 110 milliseconds. Data Packets delivered across Europe make the trip there and back in an average of around 14 milliseconds, while round trip across North America takes approximately 40 milliseconds.

Whether these data delays have any perceptible difference on performance depends on what the application is. For example, it takes the human brain around 80 milliseconds to process and synchronize sensory inputs. This lag is why, for instance, the sight and sound of someone nearby clapping their hands appear to be simultaneous even though the sound takes longer to travel than the sight. Once the delay between the two is more than 80 milliseconds, it becomes perceptible, as is the case when the slower sound of thunder from a distant location doesn't sync up with an observed lighting strike. For this reason, latency delays of 80 milliseconds or less are generally imperceptible to human users. In many cases, the small latency delays such as those associated with network packet processing times and even the time for data packets to travel many miles can often be dismissed as being negligible when a computer system interfaces with a human. A good example of this would be the loading of an Internet home page on someone's personal computer in less than 80 milliseconds. However, 80 milliseconds is far too great a delay when computers, servers and routers communicate directly with each other. For machine-to-machine (M2M) communications like this, the greater the latency the more equipment is necessary to achieve a required data flow rate. Since more machines cost more money, the overall cost effectiveness of the data center is reduced.

A particularly interesting case history relates to the strategy of “mirroring” one data center into another (maintaining a duplicate set of data) for purposes of redundancy in the event of a disaster. The mirroring operation of an entire data center (one of the largest M2M applications known) requires a large and continuous flow of updated data to and from one center to the other. Due to the effects of latency, it turns out that the mirroring operation is limited to pairs of data centers separated by less than approximately 30 miles. And depending on how the remainder of the components causing latency are managed, the maximum separation may be substantially less than 30 miles.

This engineering fact took on great significance when American Airlines Flight 11 slammed into the North Tower of the World Trade Center on September 2011 ending thousands of lives in an instant. High in that tower were the offices of securities trader Cantor Fitzgerald and over 700 of the company's employees. Yet, despite a loss that would have been fatal to most companies, Cantor Fitzgerald was in operation two days later when the stock markets reopened. The company was saved by a mirrored data center located in nearby Rochelle Park, N.J., less than 30 miles away.

Beyond this 30 mile limitation for mirrored data centers, there can be many other reasons for data center operators to invest heavily to reduce latency. For, Example, there has been a rush to find and build extremely low latency solutions for certain applications. The trend has been particularly visible in the financial sector, where a latency of only a fraction of a millisecond can make a major difference in the effects of high-frequency stock trading algorithms. For this reason, firms pay high premiums to build data centers in northern New Jersey near the servers of exchanges like the New York Stock Exchange and NASDAQ. As a result, data center real estate in northern New Jersey is worth as much as four times the cost per square foot as commercial real estate in the most expensive Madison Park and Fifth Avenue high rises in New York City, according to a recent New York Times article.

The financial industry has also worked to pioneer lower-latency technologies, such as direct laser beam transmission between the exchanges, in a race to close the gap between stock trade times and the speed of light (as recently reported by the Wall Street Journal).

In addition to high-speed trading, there is an expanding range of latency-sensitive machine-to-machine (M2M) services such as car controls and virtual networking functions. These M2M categories are growing as more connected devices come online in the burgeoning Internet of Things sector. As a result, there will be a growing need for data centers clustered near or in the same city as their endpoint data sources to serve these applications.

Not only does the desire to reduce latency affect the location choices for data centers, it also affects the cabling and switching architecture within every data center, as will be explained next.

Data center cabling is complicated enough as it is, but it would reach nightmarish levels of complexity without routers and switches to direct data traffic flowing into and through the facility. These devices serve as nodes that make it possible for data to travel from one point to another along the most efficient route possible. Properly configured, they can manage huge amounts of traffic without compromising performance and form a crucial element of data center topology.

Incoming data packets from the public Internet first encounter the data center's edge routers, which analyze where each packet is coming from and where it needs to go. From there, the edge routers hand the packets off to the core routers (switches), which form a distinct data processing layer at the facility level that manage traffic inside the data center networking architecture.

Such a collection of core switches is called the ‘aggregation level’ because they direct all traffic within the data center environment. When data needs to travel between servers that aren't physically connected by a direct cable link, it must be relayed through the core switches. If individual servers and routers were to communicate directly with one another, this would require a huge list of equipment addresses for the core switches to manage (and thereby compromise the speed of data flow). Data center networks avoid this problem by connecting batches of servers to a second layer of grouped switches. These groups are called ‘pods’ and they encode data packets in such a way that the core switch only needs to know which pod to direct traffic toward rather than addressing individual servers and routers.

### SUMMARY OF THE INVENTION

While the trend to reduce latency is almost universal in the design, location, and operation of data centers, there are certain situations where the addition of measured amounts of latency that are well placed can be financially beneficial to data center operators. At first, it may seem that any purposeful addition of latency into a data center's operation or between data centers would be both counterintuitive and counterproductive. However, this is not always true. For example, a shared data center operator may find that more customers are willing to pay a premium for various pod locations within their data center if all of these pod locations have equal latency delays from the core switch. Otherwise the pod location closest to the core switch (with the least latency) is likely to receive the most data traffic and correspondingly more revenue than the other pod locations that have a greater latency. So, this pod location can be leased at a premium price. As a consequence, the lease price for the remaining pod locations must be discounted. On the other hand, if all pod locations have identical latency relative to the central switch, they may all be offered at a premium lease price. In the past, it has not been obvious to data center operators which strategies and what specialized equipment designed to equalize latency might optimize their return on investment. That is the subject of the methods and apparatus described in the drawings that follow.

### BRIEF DESCRIPTION OF THE DRAWINGS

The above SUMMARY OF THE INVENTION as well as other features and advantages of the present invention will be more fully appreciated by reference to the following detailed descriptions of illustrative embodiments in accordance with the present invention when taken in conjunction with the accompanying drawings, wherein:

FIG. 1 is a schematic of a typical data center with pods having varying cable lengths from the core switch.

FIG. 2 is similar to FIG. 1 with one exception; all of the optical fiber link lengths between the central switch and the pods have been cut to have equal length.

FIG. 3 is similar to FIG. 1 with one exception; all of the optical fiber links between the central switch and the pods have been made to all have equal latency by the addition of varying amounts of latency at various locations within each link.

FIG. 4 is similar to FIG. 1 with one exception; all of the optical fiber links between the central switch and the pods have been made to have equal latency by the addition of a specialized piece of equipment known as a multilink equalizer apparatus adjacent to the core switch that adds selected amounts of latency to each of the outgoing links.

FIG. 5 is an isometric view of the multilink equalizer apparatus shown in FIG. 4.

FIG. 6 is an isometric view of the interior of a single equalizer module that can be inserted into the multilink equalizer apparatus.

FIG. 7 is an isometric view of one of the twelve spools that can be contained in each module shown in FIG. 6.

### DETAILED DESCRIPTION OF THE DRAWINGS

With reference to the attached drawings, embodiments of the present invention will be described in the following:

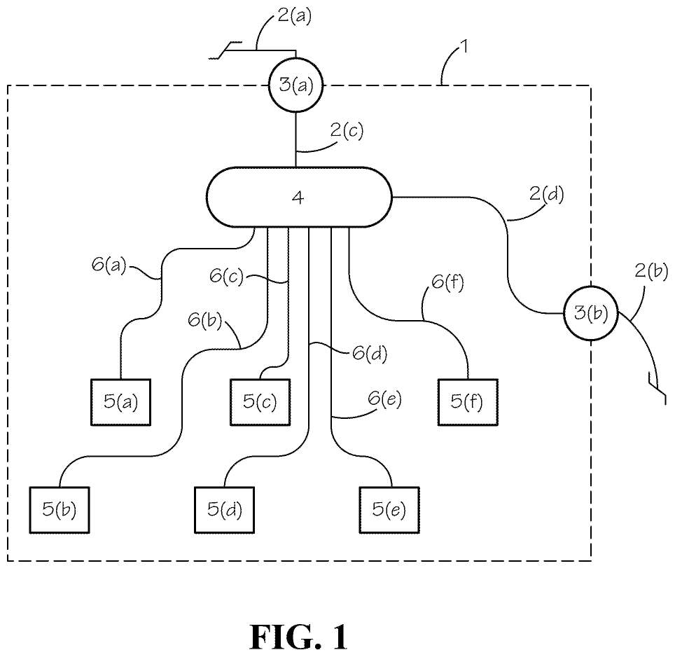

FIG. 1 is a schematic of a typical data center 1 contained within a large dashed box 1. A multiplicity of external data cables, 2(a), 2(b), etc. (implying more similar data cables may exist in a typical data center) connect to carry data to and from a multiplicity of edge routers 3(a), 3, (b), etc. (implying more similar edge routers may exist in a typical data center) which, in turn, direct the data to and from an aggregated group of routers called the core switch 4 through cables 2(c), and 2(d), etc. (implying more similar data cables may exist in a typical data center). From there, the data is directed to and from dispersed data processing pods (sometimes referred to as modules, containers, or clusters) 5(a), 5(b), 5(c), 5(d), 5(e), 5(f), etc. (implying more similar data processing pods may exist in a typical data center) through fiber optic cable links 6(a), 6(b), 6(c), 6(d), 6(e), 6(f), etc. (implying more similar fiber optic cable links may exist in a typical data center). Some larger data centers may contain a multiplicity of core switches similar to core switch 4 that are linked to other groups of pods similar to the group 5(a), 5(b), 5(c), 5(d), 5(e), 5(f), etc. shown in FIG. 1

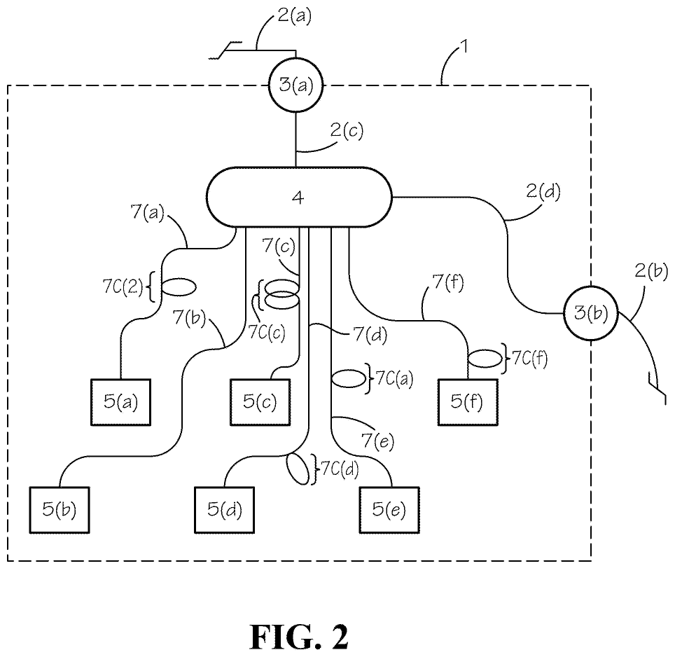

FIG. 2 is a schematic, similar to FIG. 1 with one exception; all of the optical fiber links 7(a), 7(b), 7(c), 7(d), 7(e),7(f), etc. (implying more similar optical fiber links may exist in a typical data center) between the core switch 4 and the pods 5(a), 5(b), 5(c), 5(d), 5(e), 5(f), etc. have been made to have equal lengths. Specifically, the optical fibers within these links have all been cut to the equal lengths prior to installation. This ensures that the latency associated with each of the said optical fiber links is the same. When employing this cabling design strategy in a data center, some of the optical fiber links 7(a), 7(b), 7(c), 7(d), 7(e), 7(f), etc. may be physically longer that the links 6(a), 6(b), 6(c), 6(d), 6(e), 6(f), etc. shown in FIG. 1. In this case, any excess cable lengths may be coiled as shown in locations 7C(a), 7C(c), 7C(d), 7C(e), 7C(f), etc. or simply bunched together and stored in cable troughs located within the data center. Longer excess cable lengths may be wrapped around the pod to which the cable link is directed or stored or placed in any other convenient location.

Cabling is an important aspect of data center design. Poor cable deployment can be more than just messy to look at—it can restrict airflow, preventing hot air from being expelled properly and blocking cool air from coming in. Over time, cable-related air damming can cause equipment to overheat and fail, resulting in costly downtime. As a consequence, there is an advantage in not having coils or bunches of cables scattered throughout a data center.

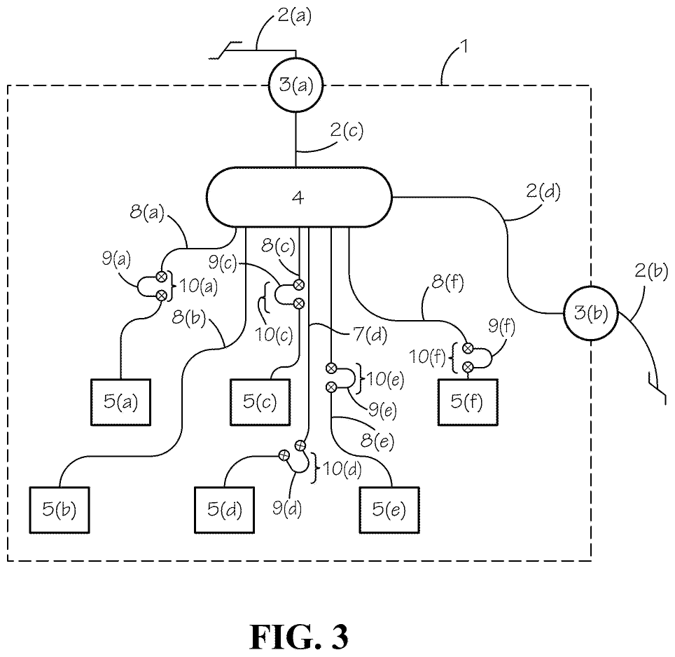

FIG. 3 is similar to FIG. 1 with one exception; all of the optical fiber links 8(a), 8(b), 8(c), 8(d), 8(e),8(f), etc. (implying more similar optical fiber links may exist in a typical data center) between the core switch and the pods 5(a), 5(b), 5(c), 5(d), 5(e), 5(f), etc. have been made to all have equal latency by splicing in additional sections of optical fiber cables 9(a), 9(b), 9(c), 9(d), 9(e),9(f), etc. to the links, as needed, at various locations 10(a), 10(b), 10(c), 10(d), 10(e),10(f), etc. that are accessible. The strategy for determining the lengths of the additional optical fiber cables 9(a), 9(b), 9(c), 9(d), 9(e),9(f), etc. would be to measure the time delay in each of the fiber optic cable links 6(a), 6(b), 6(c), 6(d), 6(e), 6(f), etc. in FIG. 1. Then use this information to calculate, measure and cut additional optical fiber cables 9(a), 9(b), 9(c), 9(d), 9(e),9(f), etc. (implying more similar optical fiber cables may exist in a typical data center) so that the time delay in each of the resulting spliced cables 8(a), 8(b), 8(c), 8(d), 8(e),8(f), etc. are equal. Measurement of the time delay can be accomplished using a conventional optical time delay reflectometer (OTDR) or some other suitable equipment. While this cabling design strategy equalizes link latency, it suffers from cluttering the data center with optical fiber cables 9(a), 9(b), 9(c), 9(d), 9(e),9(f), etc.

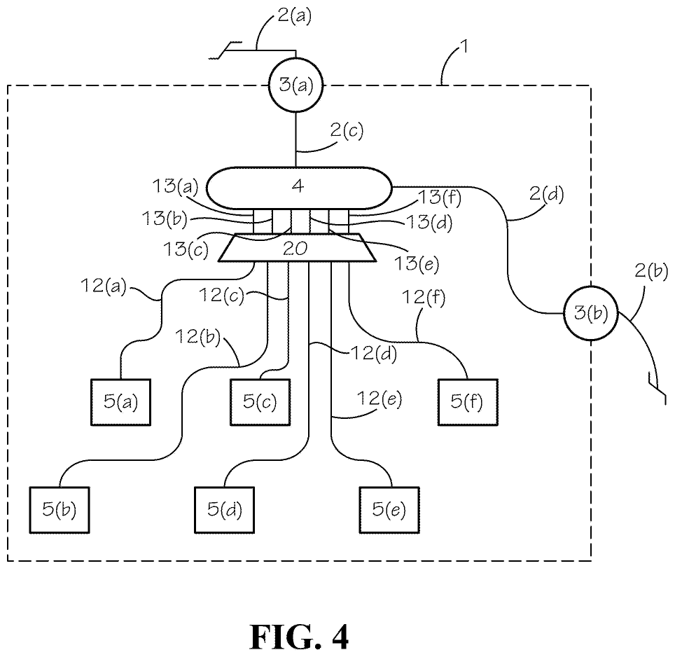

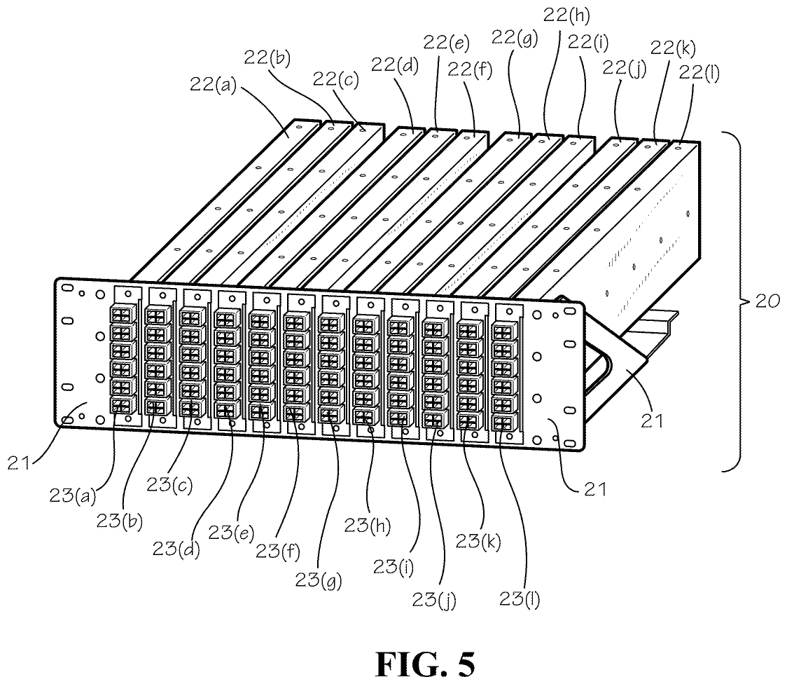

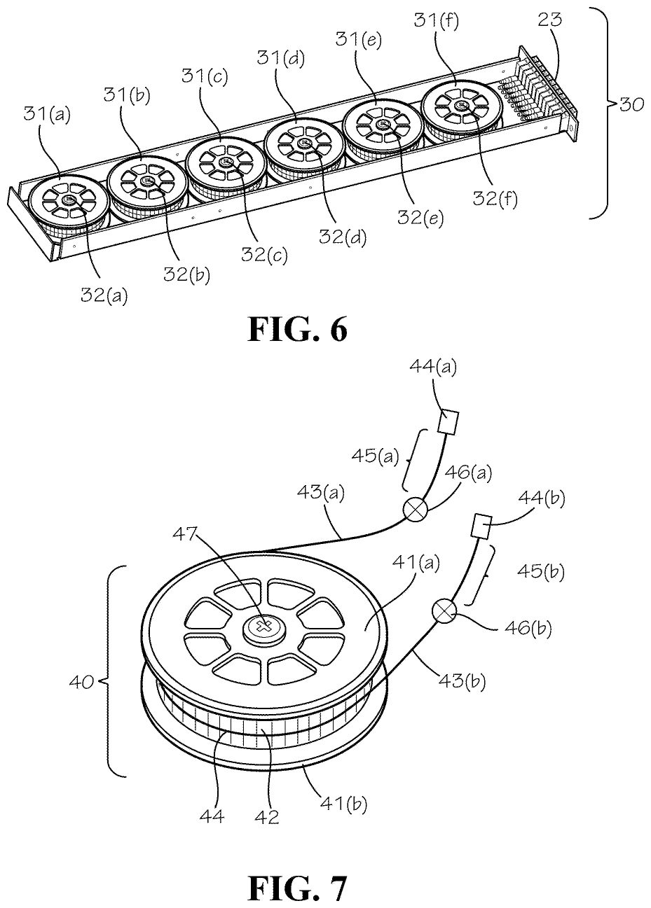

FIG. 4 is similar to FIG. 1 with one exception; all of the optical fiber links between the core switch 4 and the pods 5(a), 5(b), 5(c), 5(d), 5(e), 5(f), etc. have been made to have equal latency by the addition of a specialized piece of equipment known as a multilink equalizer apparatus 20 that is located adjacent to the core switch 4 and connected to the core switch 4 by a series of equal length fiber optic jumper cables 13(a), 13(b), 13(c), 13(d), 13(e),13(f), etc. (implying more similar fiber optic jumper cables may exist in a typical data center) that connect to the input ports of the multilink equalized apparatus 20. The output ports of the multilink equalized are connected to the outgoing fiber optic data links 12(a), 12(b), 12(c), 12(d), 12(e),12(f), etc. (implying more similar outgoing fiber optic links may exist in a typical data center). This strategy is employed to make the total latency from the core switch 4 to the pods 5(a), 5(b), 5(c), 5(d), 5(e), 5(f), etc. equal with minimum additional space requirements for the storage of cables. The design and operation of the multilink equalizer apparatus is discussed in FIG. 5, FIG. 6 and FIG. 7.

FIG. 5 is an isometric view of the multilink equalizer apparatus 20 that is shown schematically in FIG. 4. This is a novel product for equalizing link latency and system synchronization in data centers. It offers a space-efficient and scalable approach for data center engineering teams deploying time delays for latency-driven applications that require equalization.

While the size and configuration of the multilink equalizer apparatus 20 may vary depending on the application, a standard unit has a rack mounted chassis 21 is 3 RU (5¼ inches) high. This multilink equalizer apparatus accommodates up to 12 high-density modules, 22(a) through 22(l), one of which is shown in greater detail in FIG. 6. Each of these modules holds up to 12 fiber delay spools, shown in greater detail in FIG. 7, for a total of 12×12=144 time delays that can be individually specified by a data center engineering team. Each module has a group of 24 fiber optic connector ports 23(a) through 23(l). Twelve these ports are input ports connect to the core switch 4 through jumper cables 13(a), 13(b), 13(c), 13(d), 13(e),13(f), etc. shown in FIG. 4. The remaining 12 fiber optic connector ports are output ports that connect to data links 12(a), 12(b), 12(c), 12(d), 12(e),12(f), etc., also shown in FIG. 4. Having as many as 144 time delays in a single apparatus saves considerable rack space while enabling a data center engineering team to add, re-configure, and completely control their setup configuration as their data center business needs evolve. Furthermore, each time delay can be achieved with sub-nanosecond accuracy by carefully monitoring the length of optical fiber wound on each spool, delivering a superior performance level not seen before in the data center industry.

FIG. 6 is an isometric view of the interior of a single equalizer module 30 that can be inserted into the multilink equalizer apparatus 20. The module's cover has been removed and is not shown in this figure. While the size of a module can vary depending on the application, the standard module shown in this figure is 1.1 inches wide, 5.25 inches tall and 24.1 inches long. This standard module contains six pairs of spools 31(a), 31(b), 31(c), 31(d), 31 (e), and 31(f). Each pair of spools is mounted on keyed shafts 32(a), 32(b), 32(c), 32(d), 32 (e), and 32(f) that accommodate four different rotational positions for the spools. The lengths of the individual optical fibers are precisely measured as they are wound on the individual spools. And the delay time for each spool is equal to the length of the optical fiber on the spool times the velocity of light in this fiber. For example, a spool containing 100 meters of wound optical fiber would have a delay time of 0.4897 microseconds (100 meters×4.897 nanoseconds per meter).

FIG. 7 is an isometric view of one of the twelve spools that is contained in each standard module shown in FIG. 6. The standard spool 40, shown in FIG. 7, has end flanges, 41(a) and 41(b) of 3.5 inches in diameter and a central core 42 that is 2.5 inches in diameter. The standard spools are made in two sizes; one with a core width of 0.17 inches that can accommodate up to 250 meters of optical fiber and the other has a larger core width of 0.66 inches that can accommodated up to 500 meters of optical fiber with an outside diameter, including coating, of 250 microns. The two ends, 43(a) and 43(b), of optical fiber, 44, that is wound on the stool 40 can be terminated with fiber optic connectors 44(a) and 44(b). Since it is often easier to fusion splice optical fibers than to terminate them with connectors, a short fiber optic jumper cable that has been pre-terminated with connectors on both ends may be cut in half to produce two short lengths of optical fibers 45 (a) and 45(b) that can be fusion spliced at locations 46(a) and 46(b) to the two ends of the wound fiber 43(a) and 43(b). A cost-effective way to produce these spools is by using 3D Fused Deposition Modeling (FDM) printing employing a polyethylene terephthalate (PETG) polymer material. The keyway 47 on the rotational axis of the spool allows the spool to be set on and secured in four different rotational position on any one of the six keyed shafts 32(a), 32(b), 32(c), 32(d), 32 (e), and 32(f) inside of the module 30, as shown in FIG. 6. With four different rotational positions allowed for each spool, the person attaching the spool onto one of the keyed shafts in the module 30 can select the most favorable rotational position to connect the fiber optic connectors 44(a) and 44(b) on the ends of the wound fiber to mating connectors in the group of panel mounted fiber optic connectors 23.

In case one of the wound fibers in a module 30 breaks or it is desired to change a wound fiber with another one having a different time delay, a technician can pull the module from its equipment rack, remove the module's cover, disconnect the two ends of the wound fiber selected for replacement, and then slide the corresponding spool off of its keyed shaft. These steps can be reversed for the replacement of a new spool of optical fiber into the module.

While the above drawings provide representative examples of specific embodiments of the multilink equalization apparatus, numerous variations in the shape and design details of this apparatus are possible.

We claim:

1. A multilink equalizer apparatus suitable for equalizing link latency (time delay) in a group of fiber optic data links within a data center wherein the said multilink equalizer apparatus is comprised of a multiplicity of equalizer modules that are inserted into a single equipment rack mounted chassis and each of said modules contains a multiplicity of spools wound with optical fibers of varying lengths that have been precisely cut to provide various data transmission delay times (latencies) necessary to equalize the data transmission delays in said group of optical fiber data links.

2. A multilink equalizer apparatus as in claim 1 suitable for mounting in a standard 19 inch wide equipment rack space in a data center that is 3 RU (5.25 inches) high.

3. A multilink equalizer apparatus as in claim 1 containing a multiplicity of spools that have been wound with optical fibers that have been cut to various predetermined lengths of up to 800 meters for each spool.

4. A multilink equalizer apparatus as in claim 3 wherein the said predetermined fiber lengths are precise to within 10 centimeters of the nominal specified length.

5. A multilink equalizer apparatus as in claim 1 containing spools that hold wound optical fibers that are manufactured by 3D printing, such as Fused Deposition Modeling (FDM) or injection molded processes.

6. A multilink equalizer apparatus as in claim 5 wherein the polymer material, such as polyethylene terephthalate (PETG), is used to form the spools.

7. A method for equalizing latency in a group optical fiber data links within a data center employing the following steps: (1) measuring the data transmission latency (time delay) in each optical fiber within a group that has been selected for equalization using an optical time domain reflectometer (OTDR) or some other suitable equipment, (2) determining the optical fiber link in the selected group that has the maximum latency, (3) subtract the latency for each of the other optical fiber links in the group from the one with the maximum latency to determine the latency difference that must be added to each link for the purpose of equalization, (4) cut a separate length of optical fiber cable having a length that corresponds to the latency difference for each optical fiber link in the group, (5) wind each of these fibers onto a spool and mark the spool with the corresponding latency value, (6) insert all of these spools into a single equalizer module or multiple equalizer modules that are subsequently inserted into the equipment rack of a single multilink equalizer apparatus, (7) connect the cable input ports in the single multilink equalizer apparatus to the core switch in the data center using a group of equal length fiber optic jumper cables, (8) connect the cable output ports of the multilink equalizer apparatus to the corresponding fiber optical data links that are to be equalized so that the time delays (latency) in all links become equal.
